(19) United States
(12) Patent Application Publication
(10) Pub. No.: US 2011/0304118 A1
(43) Pub. Date: Dec. 15, 2011

(54) CHILD-POWERED VEHICLE

(76) Inventor: Rick A. Pettinger, Winthrop, IA (US)

(21) Appl. No.: 13/158,729

(22) Filed: Jun. 13, 2011

Related U.S. Application Data
(60) Provisional application No. 61/353,908, filed on Jun. 11, 2010.

(51) Int. Cl. B62M 1/02; B62K 21/00

(52) U.S. Cl. 280/259; 280/263

(57) ABSTRACT

A child-powered vehicle including a body, a front axle rotatably coupled to the body, a rear axle assembly pivotally coupled to the body, and a pair of pedals that drives the front axle and associated wheels for movement. The rear axle is pivotable about a steering axis to alter the orientation of the rear axle with respect to the front axle, such that the steering axis is non-parallel to the rear axle to provide a small turning radius.

### CROSS-REFERENCE TO RELATED APPLICATIONS

This application is a non-provisional of and claims priority to U.S. Provisional Patent Application No. 61/353,908 filed on Jun. 11, 2010, the entire contents of which are hereby incorporated by reference.

### BACKGROUND OF THE INVENTION

Numerous variations of pedal driven vehicles are available on today's market. Many of these vehicles are marketed towards younger children and toddlers with each vehicle attempting to provide children with a safe, yet exciting experience. Unique forms of propulsion and control are common ways of providing variations to everyday vehicles such as tractors, cars, trucks, airplanes, motorcycles, and the like.

Furthermore, care must be taken to assure a limited number of exposed pinch points, danger zones, rotating sprockets and the like are present on each vehicle. Many times, if a child or caregiver is not careful, a finger, toe, or other extremity may become lodged or injured by the vehicle.

### SUMMARY OF THE INVENTION

The present invention relates to a pedal vehicle, and more specifically to a pedal vehicle with improved steering capabilities.

In one embodiment, the invention provides a user powered vehicle comprising a body, a pedal assembly rotatably coupled to body, a front axle rotatably coupled to the body and driven by the pedal assembly, and a rear axle coupled to the body, wherein the rear axle is pivotable about a steering axis to alter the orientation of the rear axle with respect to the front axle, and wherein the steering axis is non-parallel to the rear axle.

In another embodiment, the invention provides a user powered vehicle comprising a body, a pedal assembly rotatably coupled to the body, a front axle assembly rotatably coupled to the body, a steering box pivotably coupled to the body and pivotable about a steering axis, and a rear axle rotatably coupled to the steering box, wherein rotation of the steering box about the steering axis alters the orientation of the rear axle with respect to the front axle.

In yet another embodiment, the invention provides a user powered vehicle comprising a body having a pivot boss and defining a cavity therein, a pedal assembly rotatably coupled to the body, a front axle assembly rotatably coupled to the body and driven by the pedal assembly, a steering assembly at least partially positioned within the cavity, a steering box pivotably mounted on the pivot boss and pivotable about a steering axis, and a rear axle rotatably coupled to the steering box, wherein rotation of the steering box about the steering axis alters the orientation of the rear axle with respect to the front axle, and wherein the steering axis is substantially perpendicular to the rear axle.

### BRIEF DESCRIPTION OF THE DRAWINGS

FIG. 1 is an exploded perspective view of the vehicle of the present invention with a section taken from the frame for clarity.

FIGS. 2a-2c illustrate a frame of the vehicle of FIG. 1.

FIGS. 3a-3b illustrate a front axle assembly of the vehicle of FIG. 1.

FIGS. 4a-4b illustrate a pedal assembly of the vehicle of FIG. 1.

FIGS. 5a-5c illustrate a steering box of the vehicle of FIG. 1.

FIG. 6 illustrates a steering plate of the vehicle of FIG. 1.

FIGS. 7a-7c illustrate an axle cover of the vehicle of FIG. 1.

FIGS. 8a-8c illustrate the vehicle of FIG. 1 in various steering configurations.

### DETAILED DESCRIPTION

It is to be understood that the invention is not limited in its application to the details of construction and the arrangements of the components set forth in the following description or embodiments, or illustrated in the drawings. The invention is capable of other embodiments and of being practiced or being carried out in various ways. Also, it is to be understood that the phraseology and terminology used herein is for the purpose of description and should not be regarded as limiting.

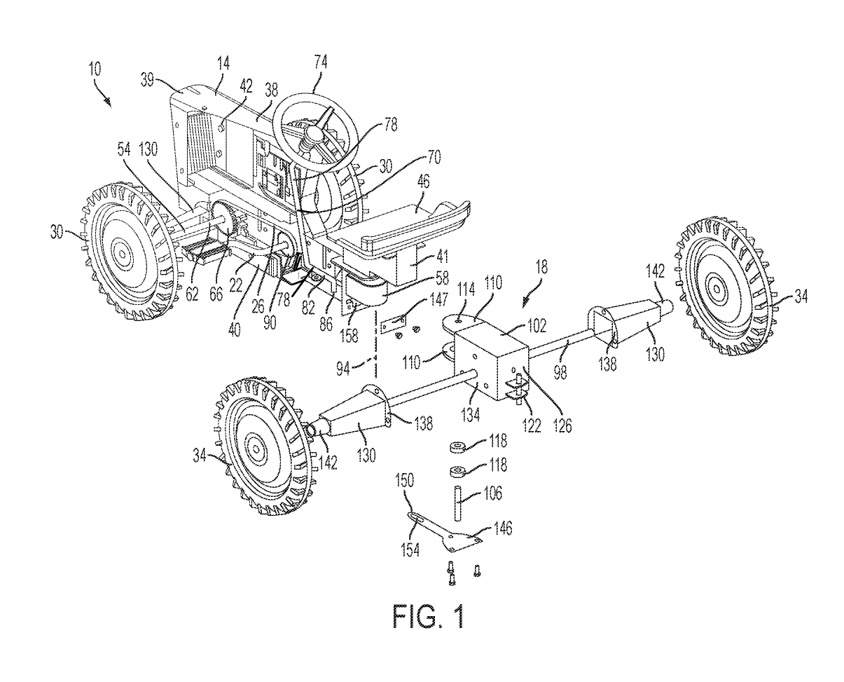

FIG. 1 illustrates a user-powered vehicle 10 including a body 14 and a rear axle assembly 18 pivotally coupled to the body 14. The vehicle 10 is configured to be ridden by a user, such as a small child or toddler, who manually propels the vehicle 10 by rotating a pair of pedals 22, which in turn rotates front wheels 30 by way of a belt or chain 26. The pivoting rear axle assembly 18 (described below) is configured to provide an improved (i.e., smaller) turning radius compared to vehicles of similar size and wheelbase dimensions having front-wheel steering. In the illustrated construction, propulsion from the pedals 22 is directed solely toward the front wheels 30 of the vehicle 10, however in alternate constructions, propulsion may be directed to any combination of wheels, including only to rear wheels 34, or to both the front wheels 30 and rear wheels 34.

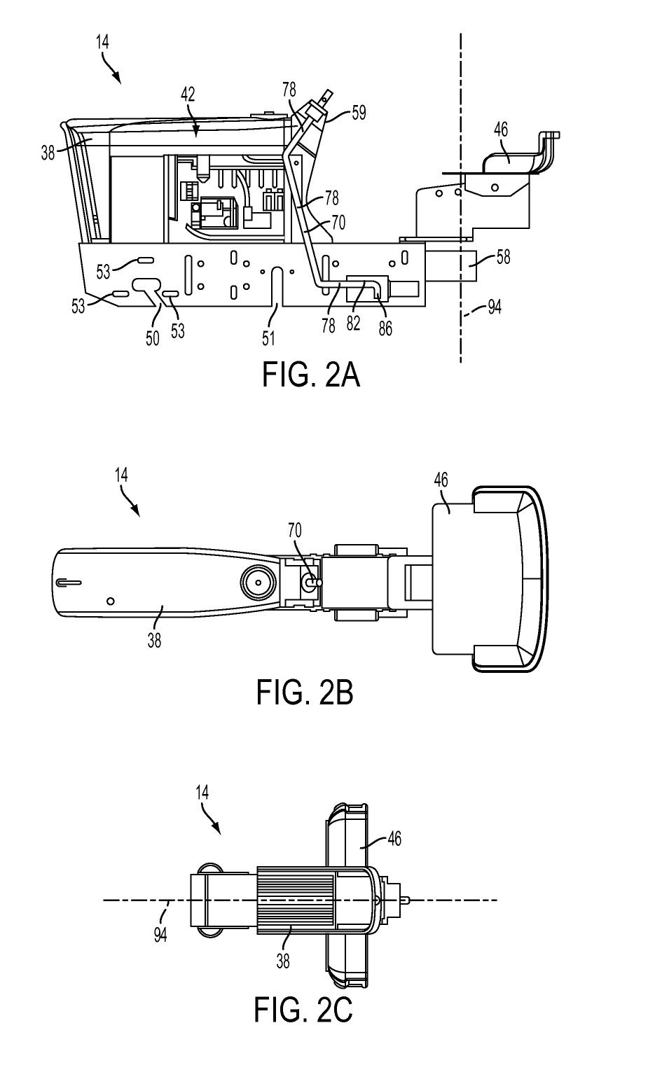

Illustrated in FIGS. 1 and 2a-2c, the body 14 of the vehicle 10 includes a housing or frame 38 shaped generally as a tractor. The frame 38 may be made of, for example, one or more injection molded plastic pieces that are assembled by way of various snap fits, fasteners, and the like. The frame 38 may alternatively be made of metal components formed by stamping, forging, casting, or other known fabrication techniques. In some forms, the frame 38 includes combinations of plastic and metal components.

When assembled, the frame 38 includes a hood portion 39 that generally represents the hood and engine compartment of a full-sized tractor, a chassis portion 40 that generally represents the chassis or frame portion of a full sized tractor, and a seat portion 41. The frame 38 also defines a cavity 42 for housing various operating components of the vehicle 10. A seat 46 on which the user may sit is supported by the seat portion 41 of the frame. In some constructions the seat 46 may be formed integrally with the chassis portion 40. While the illustrated construction depicts a tractor, and includes features and indicia resembling a motor, lights, and other details, alternative constructions of the body 14 may depict a car, a plane, a motorcycle, a bulldozer, or substantially any other type of vehicle.

The frame 38 includes a plurality of mounting locations for supporting various components of the vehicle 10. Specifically, the frame 38 includes a first mounting location 50 for supporting a front wheel assembly 54, and a second mounting location 51 for supporting the pedal assembly 22. The frame 38 also includes a pivot boss 58 extending rearwardly from the chassis portion 40 for pivotally coupling the rear axle assembly 18 to the frame 38, and a steering column 59 for supporting a steering assembly 70.

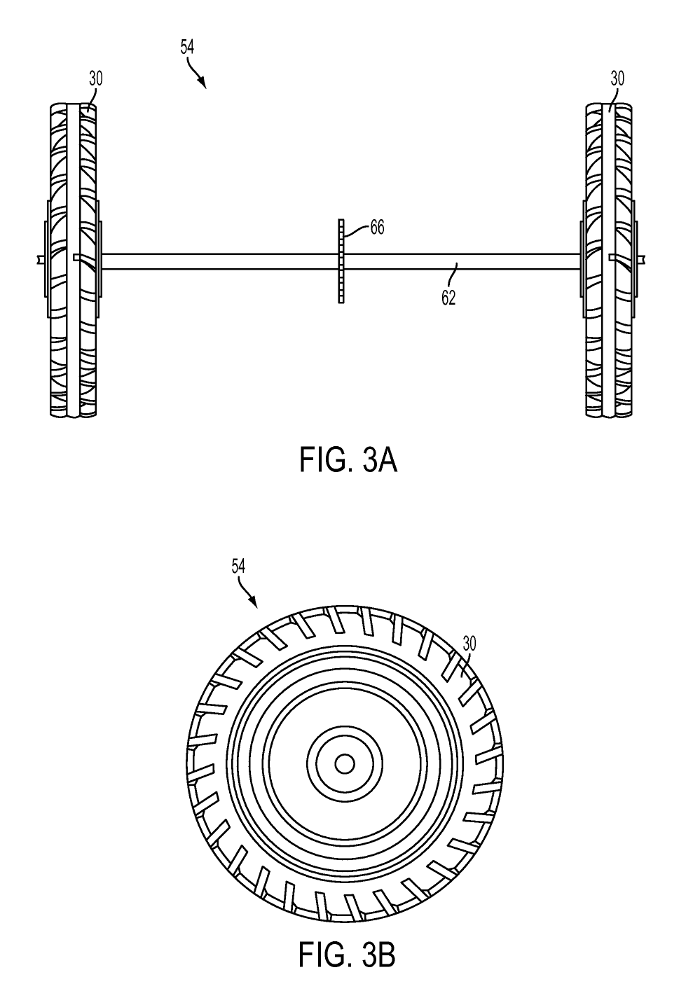

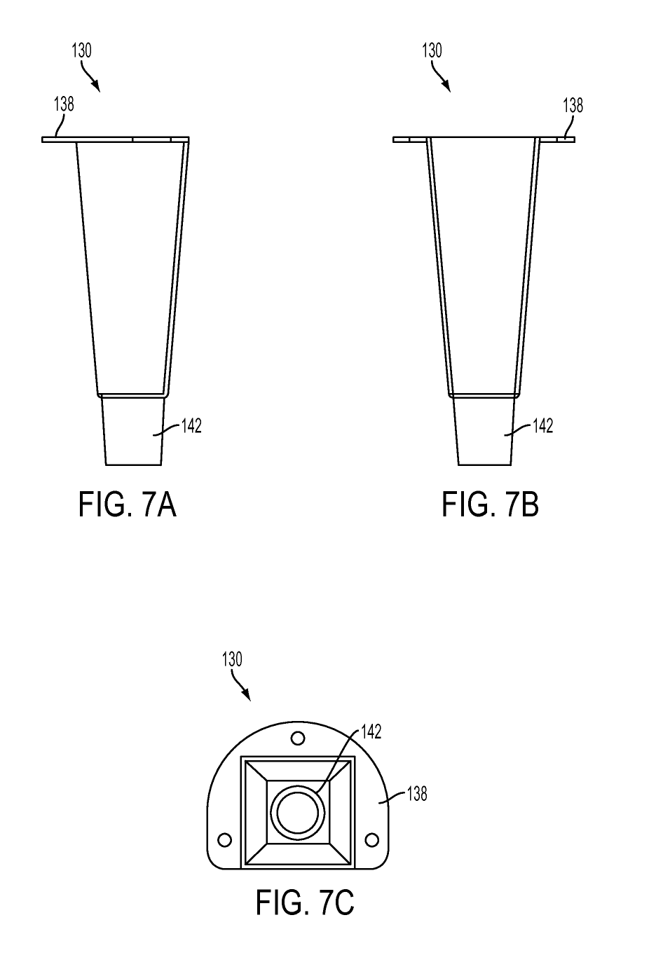

The front wheel assembly 54 (see FIGS. 3a-3c) is rotatably coupled to the frame 38 at the first mounting location 50. The front wheel assembly 54 includes the wheels 30, an axle 62 extending between the wheels 30, and a sprocket or pulley 66 coupled to the axle 62. The front wheel assembly 54 is coupled to the frame 38 by a pair of axle covers 130 (see FIGS. 7a, 7b, 7c). Each axle cover 130 includes a flange portion 138 at a first end and tapers to define a bearing portion 142 on an opposite end. The flange portions 138 of each axle cover are coupled to mounting slots 53 defined by the chassis portion 40. The axle 62 extends through and is supported by the bearing portions 142 of each axle cover 130. In the illustrated construction, the inner diameter of the bearing portion 142 substantially corresponds to the outer diameter of the axle 62 such that the axle 62 rotates freely within the bearing portion 142. However in alternate constructions, a bushing or bearing member (not shown) may be positioned between the axle 98 and the bearing portion 142 to reduce friction and wear.

The axle 62 also extends through the generally T-shaped opening of the first mounting location 50. Because the flange portions 138 are mounted in slots 53 and the first mounting location is elongated, the entire front wheel assembly 54 can be moved forwardly and rearwardly to adjust the tension in the chain 26. The sprocket 66 is received within the cavity 42 and surrounded by the chassis portion 40 of the frame 38. In some constructions, the front wheel assembly 54 may also include brakes (not illustrated) for slowing and stopping the vehicle 10. In still other constructions, the front wheel assembly 54 may be pivotable about a substantially vertical axis (not shown) so that the front wheels 30 can also be used to steer the vehicle 10.

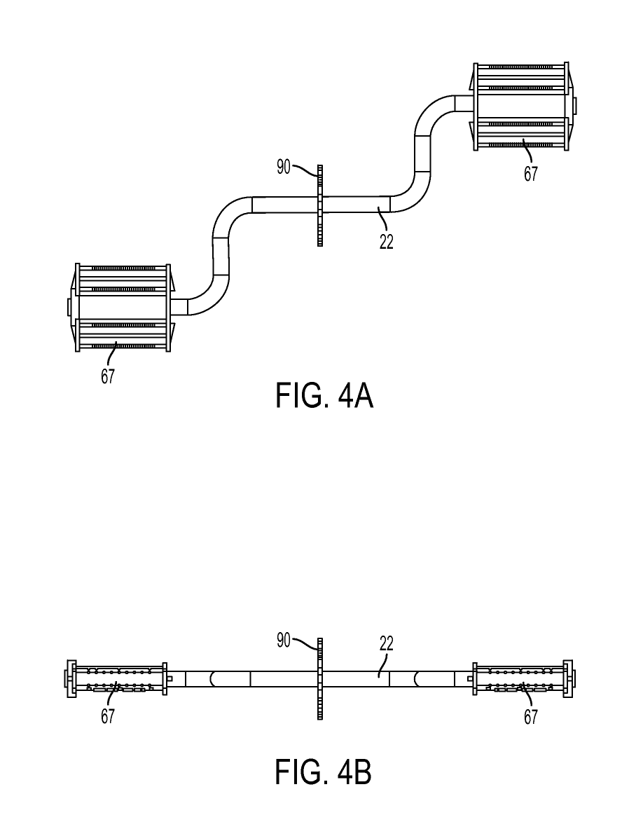

The pedal assembly 22 (FIGS. 4a, 4b) is coupled the chassis portion 40 at the second mounting location 51. The pedal assembly includes the pedals 67 and a sprocket 90, and is rotatably coupled to the chassis portion 40 by mounting plates (not shown). The sprocket 90 of the pedal assembly 22 is coupled to the sprocket 66 of the front wheel assembly 54 by the chain 26 such that rotation of the pedals 67 causes rotation of the front axle 62 and wheels 30. In the illustrated construction there is a direct-drive relationship between the pedals 67 and the wheels 30 so that the user can drive the vehicle 10 in forward or reverse directions. In other constructions, a freewheeling assembly may be incorporated into the drive mechanism such that the user only drives the wheels in the forward direction.

With reference to FIGS. 1 and 5a-7c, the rear axle assembly 18 of the vehicle 10 is pivotally coupled to frame 38 by the pivot boss 58. The pivot boss 58 extends rearwardly from the chassis portion 40 and includes a cylindrical portion (not shown) that defines a substantially vertical steering axis 94. In the illustrated construction the steering axis 94 extends through the seat portion 41 of the frame, and is positioned substantially directly below the seat 46. In other constructions the steering axis 94 may be moved forwardly or rearwardly by changing, for example, the length and location of the pivot boss 58 with respect to the chassis portion 40.

The rear axle assembly 18 includes a steering box 102, a rear axle 98, a pair of axle covers 130, the rear wheels 34, and a steering plate 146. The steering box 102 includes a pair of vertically spaced-apart projections 110 that are configured to receive between them the pivot boss 58. Each projection 110 includes an aperture 114 that is configured for alignment with the steering axis 94. Each projection 110 also includes a bearing seat 112 for receiving one of a pair of pivot bearings 118. A pivot shaft 106 extends through the bearings 118 and through the cylindrical portion of the pivot boss 58 to pivotally couple the steering box 102 to the pivot boss 58. The pivot shaft 106 is at least partially held in place by the steering plate 146, as discussed further below.

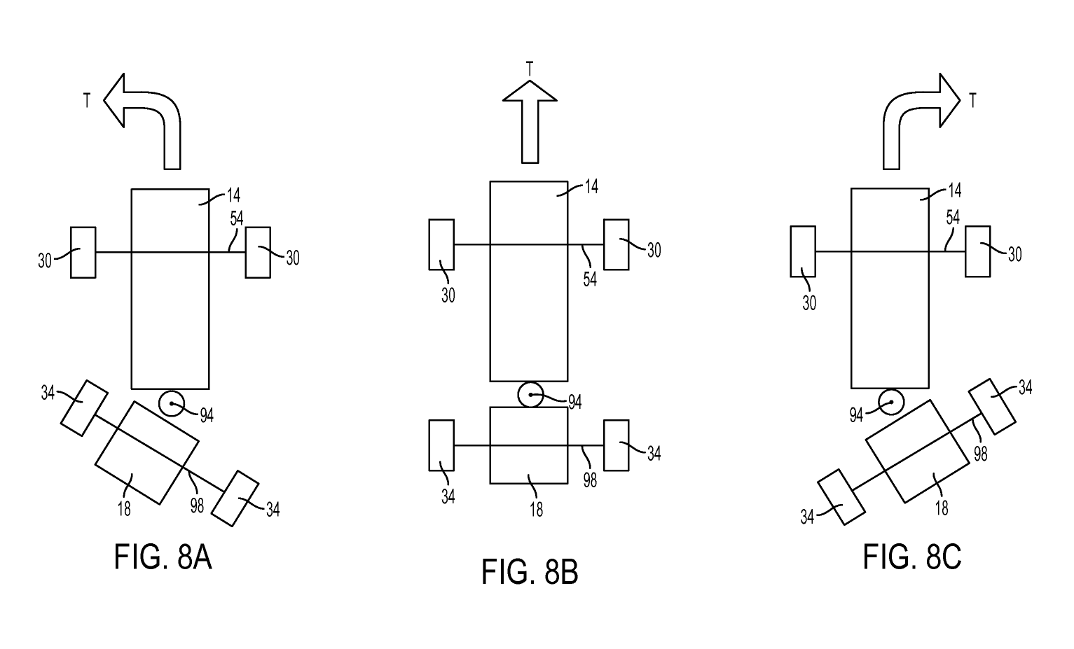

The steering box 102 includes a central aperture 103 through which the rear axle 98 extends, and three mounting apertures 104 surrounding the central aperture 103. Like the front wheel assembly 54, the rear axle 98 and the rear wheels 34 are coupled to the steering box 102 by axle covers 130. In the illustrated construction, the same axle covers 130 are used on both the front wheel assembly 54 and the rear axle assembly 18, it should be appreciated, however, that different axle covers may be used in the front and rear of the vehicle, if desired, to provide a different aesthetic appearance, or to provide different spacing between the front wheels 30 and the rear wheels 34. In the rear axle assembly 18, the rear axle 98 is supported by the bearing portions 142 of the axle covers 130, and the flange portions 138 of the axle covers 130 are coupled to the mounting apertures 104 of the steering box 102. In this way, pivotal movement of the steering box 102 pivots the rear axle 98 relative to the front axle 62, thereby steering the vehicle 10 to the left or right (see FIGS. 8a, 8b, 8c). In some constructions, the steering box 102 may also include a trailer hitch or pin 122 positioned on the rearward most panel 126 to which a trailer or additional accessories (not shown) may be coupled.

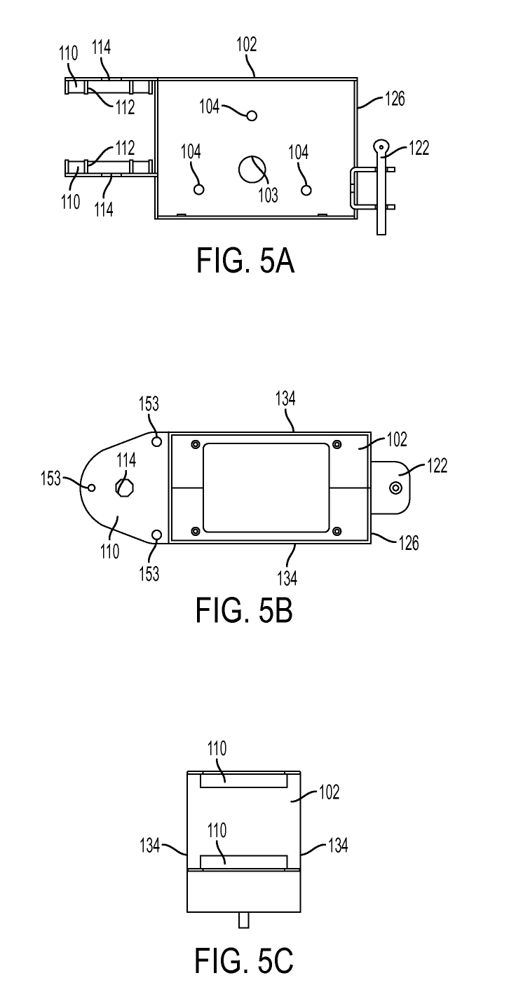

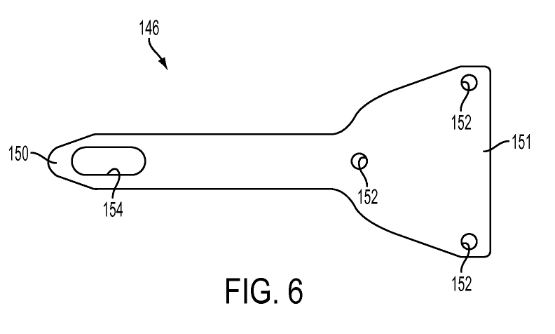

The rear axle assembly 18 also includes a steering plate 146 (see FIG. 6). The steering plate 146 is fixedly coupled to the underside of the steering box 102 such that lateral movement of a distal end 150 of the steering plate 146 causes the rear axle assembly 18 to pivot about the axis 94. The steering plate 146 includes a large end 151 having three mounting apertures 152. The mounting apertures 152 allow the steering plate 146 to be coupled to the lower of the two projections 110 of the steering box 102, which is provided with a corresponding set of three mounting apertures 153 (see FIG. 5a). When the steering plate 146 is coupled to the lower of the two projections 110, the large end 151 covers the aperture 114, thereby preventing the pivot shaft 106 from falling out of the pivot boss 58. Furthermore, when the rear axle assembly 18 is coupled to the frame 38, the steering plate 146 extends through an aperture 158 in the frame 38 (see FIG. 1) and into the cavity 42 for engagement with the steering assembly 70, as discussed further below. A cover plate 147 is secured over a portion of the aperture 158 such that only a small slot-like portion of the aperture 158 is exposed to permit movement of the steering plate 146. The cover plate 147 reduces the likelihood of a user pinching his/her fingers or other extremities between the steering plate 146 and the frame 38 during operation of the vehicle 10.

The steering assembly 70 includes a plurality of rotatable rods 78 that extend through the cavity 42 of the frame 38. On one end, the rods 78 are supported by the steering column 59 and are coupled to a steering wheel 74, which is manipulated by the user to steer the vehicle. On the opposite end, the rods 78 are coupled to a pivoting arm 82 that terminates in a finger 86. The rods 78 are coupled to one another by universal joint such that rotation of the steering wheel 74 causes rotation of the rods 78. The rods operate to pivot the pivoting arm 82 such that the finger 86 moves from side to side in response to rotation of the steering wheel 74.

The finger 86 is received within the slot 154 in the distal end 150 of the steering plate 146. Thus, when the steering wheel is rotated by the user, the finger 86 moves from side to side which in turn pivots the steering plate and steering box 102 about the steering axis 94. Because the rods 78, arm 82, finger 86 and distal end 150 of the steering plate 146 are positioned within the cavity, there is a reduced likelihood that a user will pinch his/her fingers or other extremities steering the vehicle. In alternative constructions, the steering linkage 70 may also include, without limitation, gears, pulleys, chains, levers, or any combination thereof.

The rear axle assembly 18 may be installed on the frame 38 as a unit. The axle covers 130 are coupled to the side panels 134 of the steering box 102. The bearing members 118 (when present) are coupled to the projections 110. The rear axle 98 is positioned within the axle covers 130, passing through the steering box 102. The rear wheels 34 are coupled to the ends of the axle 98. The apertures 114 of the projections 110 of the steering box 102 are aligned with the cylindrical portion of the pivot boss 58. The pivot shaft 106 is inserted between the steering box 102 and the pivot boss 58. The distal end 150 of the steering plate 146 is inserted into the aperture 158 of the frame 38 and the finger 86 is positioned in the slot 154. The large end 151 of the steering plate 146 is then coupled to the lower one of the projections 110.

Various features and advantages of the invention are set forth in the following claims.

What is claimed is:

1. A user powered vehicle comprising:
a body;
a pedal assembly rotatably coupled to body;
a front axle rotatably coupled to the body and driven by the pedal assembly; and
a rear axle coupled to the body, wherein the rear axle is pivotable about a steering axis to alter the orientation of the rear axle with respect to the front axle, and wherein the steering axis is non-parallel to the rear axle.

2. The user powered vehicle of claim 1, further comprising a steering box pivotably coupled to the body, and wherein the rear axle is rotatably mounted to the steering box.

3. The user powered vehicle of claim 2, wherein the body includes a pivot boss and the steering box is pivotably mounted to the pivot boss.

4. The user powered vehicle of claim 1, wherein the steering axis is substantially perpendicular the rear axle.

5. The user powered vehicle of claim 1, wherein the body includes a seat, and wherein the steering axis passes through the seat.

6. The user powered vehicle of claim 1, wherein the body includes a steering assembly, and wherein the steering assembly is operable to rotate the rear axle about the steering axis.

7. The user powered vehicle of claim 3, wherein the rear axle assembly includes a steering plate coupled to the steering box, and wherein lateral movement of a distal end of the steering plate causes the rear axle assembly to pivot about the steering axis.

8. A user powered vehicle comprising:
a body;
a pedal assembly rotatably coupled to the body;
a front axle assembly rotatably coupled to the body;
a steering box pivotably coupled to the body and pivotable about a steering axis; and
a rear axle rotatably coupled to the steering box, wherein rotation of the steering box about the steering axis alters the orientation of the rear axle with respect to the front axle.

9. The user powered vehicle of claim 8, wherein the body includes a pivot boss and wherein the steering box is pivotably coupled to the pivot boss.

10. The user powered vehicle of claim 8, wherein the steering axis is substantially perpendicular the rear axle.

11. The user powered vehicle of claim 8, wherein the body includes a seat, and wherein the steering axis passes through the seat.

12. The user powered vehicle of claim 8, wherein the front axle is driven by the pedal assembly.

13. The user powered vehicle of claim 8, further comprising a steering assembly, and wherein the steering assembly is operable to rotate the steering box about the steering axis.

14. A user powered vehicle comprising:
a body having a pivot boss and defining a cavity therein;
a pedal assembly rotatably coupled to the body;
a front axle assembly rotatably coupled to the body and driven by the pedal assembly;
a steering assembly at least partially positioned within the cavity;
a steering box pivotably mounted on the pivot boss and pivotable about a steering axis; and
a rear axle rotatably coupled to the steering box, wherein rotation of the steering box about the steering axis alters the orientation of the rear axle with respect to the front axle, and wherein the steering axis is substantially perpendicular to the rear axle.

15. The user powered vehicle of claim 14, wherein the body includes a seat, and wherein the steering axis passes through the seat.
